(19) United States
(12) Patent Application Publication
(10) Pub. No.: US 2019/0367704 A1
(43) Pub. Date: Dec. 5, 2019

(54) Methods of Producing Cellulose Nanocrystals

(71) Applicant: UCHICAGO ARGONNE, LLC, Chicago, IL (US)

(72) Inventors: Erik Dahl, Oak Park, IL (US); Gregory K. Krumdick, Homer Glen, IL (US); Krzystof Pupek, Plainfield, IL (US)

(21) Appl. No.: 16/000,390

(22) Filed: Jun. 5, 2018

(51) Int. Cl. C08L 1/02; D21C 9/00; C08B 15/02

(52) U.S. Cl. CPC C08L 1/02; D21H 11/16; C08B 15/02; D21C 9/004

(57) ABSTRACT

Presented herein for the first time are novel and highly efficient methods for producing CNCs. In exemplary embodiments, the method comprises mixing in a single reaction vessel a cellulose pulp, an acidic solution; and sodium chlorite, wherein the sodium chlorite reacts to form a bleaching agent, chlorine dioxide, wherein bleaching and acid hydrolysis of the cellulose pulp occurs in the single reaction vessel. In alternative or additional embodiments, the method comprises mixing with a resonant acoustic mixer a high consistency cellulose pulp with an acidic solution in a reaction vessel. Related methods, compositions, and articles of manufacture are further provided herein.

### GRANT FUNDING DISCLOSURE

This invention was made with government support under LDRD 2017-159-R1 awarded by Argonne National Laboratory. The government has certain rights in the invention.

### BACKGROUND

Cellulose is the most abundant natural polymer available in the world, as it occurs in plants, algae, fungi, bacteria, and some tunicates. Advantageously, cellulose is biodegradable, biocompatible, and renewable. Its structure is hierarchal; D-glucose units connected by β(1→4)-glycosidic bonds form straight, unbranched polymer chains. The individual cellulose chains assemble together to form protofibrils, or elementary fibrils, and the aggregation of these structures by coalescence leads to the formation of microfibrils. Microfibrils consist of tightly packed cellulose chains that form crystallites, as well as less-ordered chains, which form amorphous regions. Extraction of the highly crystalline regions of microfibrils can be extracted to form cellulose nanocrystals (CNCs) through mechanical, chemical, and/or enzyme treatment(s). CNCs are “stiff, rod-like particles consisting of cellulose chain segments in a nearly perfect crystalline structure.” George and Sabapathi, Nanotechnology, Scient and Applications 8: 45-54 (2015).

CNCs, also known as, whiskers, nanofibers, microcrystallites, are widely applicable in multiple fields because of their nanometer size, large aspect ratio, low density, and high fiber tensile strength, among other excellent mechanical and chemical characteristics, including high surface area, unique liquid crystalline properties, low coefficient of thermal expansion, and high elastic moduli. The industrial applications of CNCs span throughout the fields of medicine, electronics, aerospace, automotives, and material sciences, and include, for example, drug delivery agents, coatings, supports for catalysts, energy storage materials, reinforced plastics, aerogels, hydrogels, pickering emulsifiers, textiles, filtration systems, membranes, films, molecular scaffolds and electrospun fibers (George and Sabapathi, 2015, supra; Grishkewich et al., Curr Opin in Colloid & Interface Sci 29: 32-45 (2017)).

Much of the CNC research and development focuses on its preparation from different types of biomass, as well as the subsequent functionalization of the nanocrystal. CNCs may be produced from a variety of sources including cotton, wheat straw, and wood. The typical procedure for making CNCs requires mechanical or chemical pulping of the biomass followed by washing, base-catalyzed hydrolysis for the removal of hemicellulose and lignin, further washing, lignin removal via one or more oxidation steps, followed by additional washing. The purified cellulose that remains after this process is then subjected to acid hydrolysis to degrade the amorphous portion of the cellulose, producing a largely crystalline nanoparticle made of cellulose (i.e., a CNC). CNCs obtained from different sources often vary in crystallinity, nanofiber dimensions, and stiffness.

Though many applications have been developed for CNCs, their widespread use has been hindered by high production costs. Low efficiency, high feedstock costs and poorly scalable processes have prevented industrial scale production of CNCs. For example, the production of cellulosic compounds from wood or grass feedstock requires many steps to break down the structure of the biomass and isolate useable cellulose fibers from the structure of the plant, and these processes necessarily generate large amounts of contaminated waste water. As a result, industrial mills employ intensive processes to reuse and recycle as many of the reagents, byproducts, and water as possible. Most efforts to scale-up CNC production have involved little more than carrying out the laboratory-scale process with larger equipment. However, scaling these methods to a capacity of even one ton per day would prohibitively require massive facilities. The pilot plants that currently exist do not use native cellulose as a feedstock, and instead require dissolving pulp as a cellulose source, a very expensive source of cellulose.

Methods currently used to extract CNC from herbaceous biomass require long residence times causing the entire process to take days. Not only are these methods inefficient with respect to time, the current methods for producing CNC from herbaceous biomass also are optimized for laboratory conditions that rely on expensive reagents and poorly scalable separations techniques. Methods utilizing wood as a source, require pulp or paper products, e.g., high purity dissolving pulp, that are highly refined and made via sulfuric acid hydrolysis. This feedstock is not only high in cost but dissolving pulp treated with sulfuric acid yields CNCs with less desirable characteristics, e.g., lower aspect ratios.

In view of the foregoing, there is a need in the art for cost- and time-efficient methods for producing high quality CNCs, which methods can be scaled up to provide ton quantities of product.

### SUMMARY

Presented herein for the first time are novel and highly efficient methods for producing CNCs. In exemplary embodiments, the methods of the present disclosure advantageously combine multiple process steps which may be carried out in a single reaction vessel. For example, when the cellulose pulp, acidic solution and sodium chlorite are mixed in a single reaction vessel, the steps of bleaching agent generation (e.g., generation of chlorine dioxide), as well as the steps of bleaching and acid hydrolyzing the cellulose pulp, occur in the same reaction vessel. Because steps are combined, the method may be carried out with shorter residence times. Since multiple steps are simultaneously carried out in a single reaction vessel, reactants and reagents unused in a first round of reactions may be utilized in subsequent reactions, thereby reducing the amount of wasted reactants or reagents. Also, in exemplary embodiments, the presently disclosed methods are carried out with minimal amounts of water leading to very high pulp consistencies. Despite the challenges of working with high consistency pulps, the methods unexpectedly achieve sufficient mixing of reactants in shorter residence times through the use of resonant acoustic mixing (RAM). The use of RAM minimizes fiber damage while allowing for rapid mass transfer and heat transfer. Accordingly, in view of the above advantages, the methods of the present disclosure significantly increase efficiency and reduce the cost of CNC production. Also, the methods of the present disclosure are scalable and have been practiced at scales for the production of grams to several kilograms. Without being bound to a particular theory, the methods of the present disclosure may be scaled up to produce 5 tons to 50 tons per day. Additionally, the methods are suitable for use with particular grass feedstocks, such as Miscanthus X Giganteus, which when used, produce longer crystals and may be impart further advantages to the methods of the present disclosure.

Accordingly, the present disclosure provides methods for producing CNCs. In exemplary embodiments, the method is a method for producing acid-hydrolyzed, de-lignified CNCs and the method comprises mixing in a single reaction vessel a cellulose pulp, an acidic solution, and sodium chlorite, wherein the sodium chlorite reacts to form a bleaching agent, chlorine dioxide, wherein bleaching and acid hydrolysis of the cellulose pulp occurs in the single reaction vessel. In exemplary embodiments, the method is a method for producing acid-hydrolyzed CNCs and the method comprises mixing with a resonant acoustic mixer a high consistency cellulose pulp with an acidic solution in a reaction vessel.

The present disclosure also provides methods for reducing lignin content of a cellulose pulp. In exemplary embodiments, the method comprises mixing via resonant acoustic mixing a cellulose pulp in a basic solution at a temperature of greater than about 50° C. for at least one hour. In exemplary aspects, the method comprises mixing via resonant acoustic mixing a cellulose pulp in a basic solution comprising not more than about 8% (w/v) base at a temperature of about 60° C. to about 150° C., optionally, about 80° C. to about 140° C., for at least one hour, optionally, about 2 hours to about 20 hours.

The present disclosure further provides a method of producing CNCs comprising reducing lignin content of a cellulose pulp in accordance with the present disclosures and (i) mixing in a single reaction vessel a cellulose pulp, an acidic solution and sodium chlorite, wherein the sodium chlorite reacts to form a bleaching agent, chlorine dioxide, wherein bleaching and acid hydrolysis of the cellulose pulp occurs in the single reaction vessel, (ii) mixing with a resonant acoustic mixer a high consistency pulp with an acidic solution in a reaction vessel, or a combination of (i) and (ii).

A composition comprising the CNCs produced by any of the methods of the present disclosure are also provided herein. In exemplary embodiments, the CNCs have a length distribution of about 250 nm to about 350 nm, a height of about 8 nm to about 10 nm, and a thickness of about 2 nm to 5 nm. Such CNCs exhibit high crystallinity with values at or above about 90%.

Further provided is an article of manufacture comprising the CNCs by any of the methods of the present disclosure are also provided herein. In exemplary aspects, the article of manufacture is a film.

### BRIEF DESCRIPTION OF THE DRAWINGS

FIG. 1 is an illustration of the structure of cellulose and a typical pathway of reactions for CNC production.

FIG. 2 is a schematic of a standard reactor set-up for CNC production.

FIG. 3 is a schematic of a reactor set-up for production of CNCs according to an exemplary embodiment of the present disclosure.

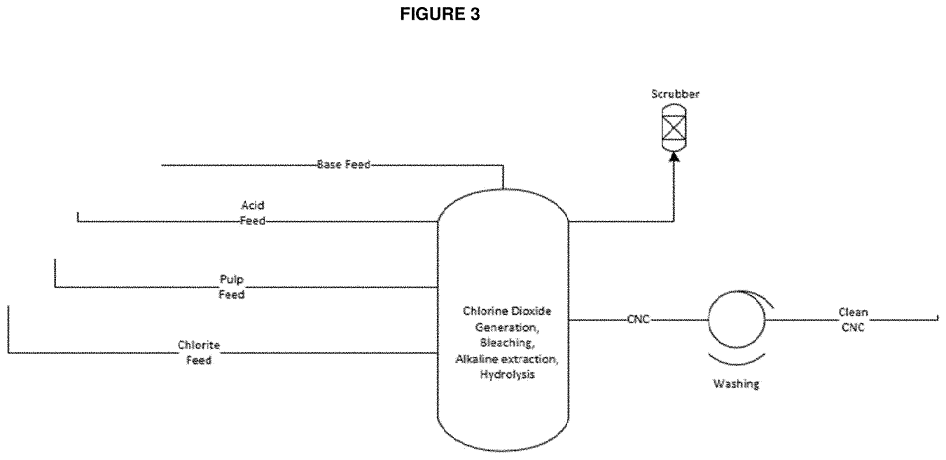

FIG. 4 is a schematic of a reactor set-up for production of CNCs with a RAM mixer according to an exemplary embodiment of the present disclosure.

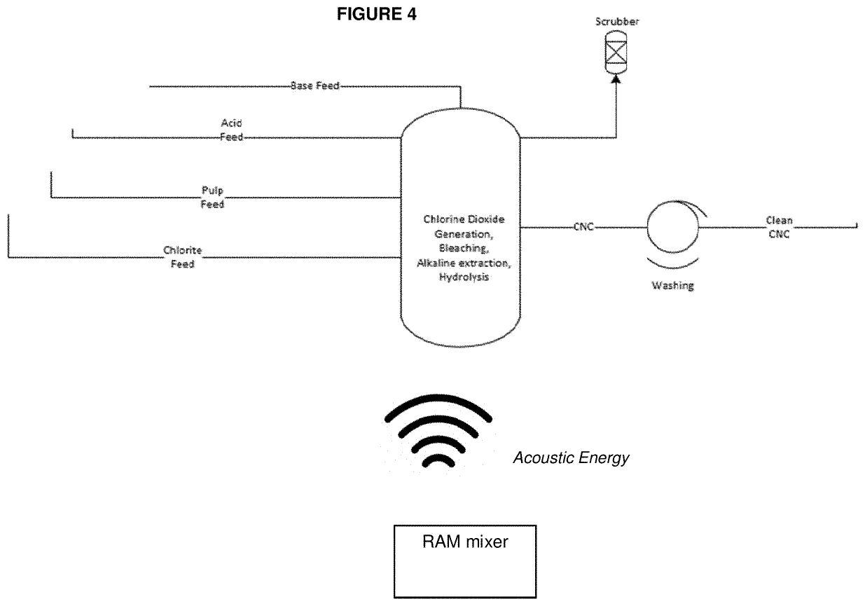

FIG. 5 is an atomic force microscopy image of the CNCs produced by exemplary methods of the present disclosure.

FIG. 6 is an x ray diffraction pattern of the CNCs of FIG. 5.

### DETAILED DESCRIPTION

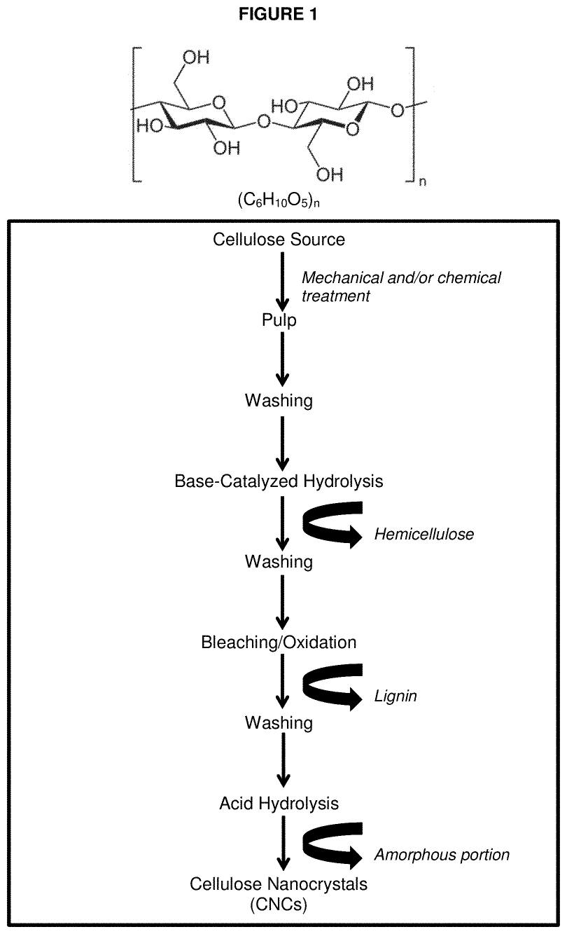

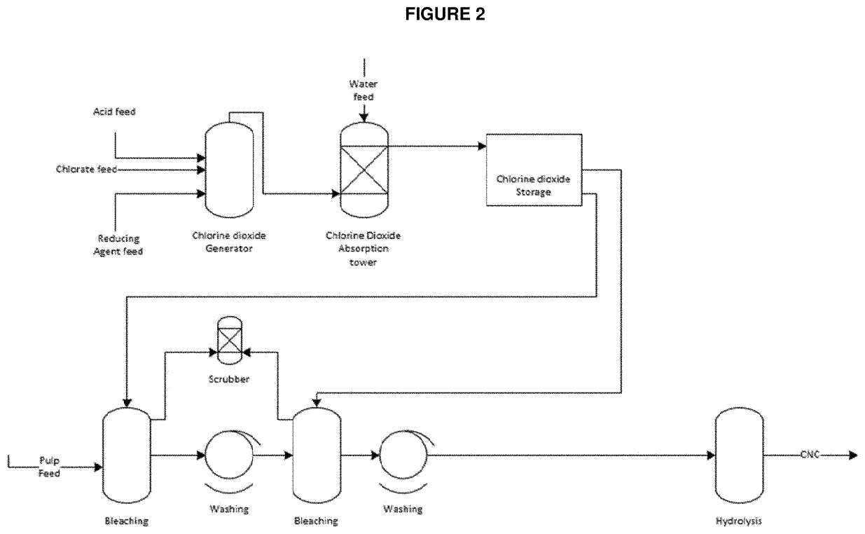

A typical pathway of reactions for CNC production is shown in FIG. 1 and a schematic of a standard reactor set-up for CNC production is shown in FIG. 2. The present disclosure provides improved methods for producing CNCs in that the methods are marked with higher efficiencies, time- and cost-wise, relative to the typical, standard processes.

In exemplary embodiments, the presently disclosed method of producing CNCs is a method for producing acid-hydrolyzed, de-lignified CNCs and, in exemplary aspects, the method comprises mixing in a single reaction vessel a cellulose pulp, an acidic solution; and sodium chlorite, wherein the sodium chlorite reacts to form a bleaching agent, chlorine dioxide, wherein bleaching and acid hydrolysis of the cellulose pulp occurs in the single reaction vessel. Because multiple steps (e.g., bleach generation, bleaching, and acid hydrolysis) are combined, the method may be carried out with shorter residence times. Since the multiple steps are simultaneously carried out in a single reaction vessel, reactants and reagents unused in a first round of reactions may be utilized in subsequent reactions, thereby reducing the amount of wasted reactants or reagents.

In exemplary embodiments, the presently disclosed methods are carried out with minimal amounts of water leading to very high pulp consistencies. Despite the challenges of working with high consistency cellulose pulps and, in some instances, ultra high consistency cellulose pulps, the methods unexpectedly achieve sufficient mixing of reactants in shorter residence times through the use of resonant acoustic mixing (RAM). The use of RAM in the presently disclosed methods minimizes fiber damage while allowing for rapid mass transfer and heat transfer. Accordingly, in exemplary embodiments, the presently disclosed method of producing CNCs is a method for producing acid-hydrolyzed CNCs and, in exemplary instances, the method comprises mixing with a resonant acoustic mixer a high consistency cellulose pulp with an acidic solution in a reaction vessel.

In exemplary embodiments, the presently disclosed method of producing CNCs is a method of producing CNCs from a cellulose pulp having a reduced lignin content, which cellulose pulp is produced by carrying out the presently disclosed methods for reducing lignin content of a cellulose pulp. The method of producing CNCs, in some aspects, comprises reducing lignin content of a cellulose pulp in accordance with the present disclosures and (i) mixing in a single reaction vessel a cellulose pulp, an acidic solution and sodium chlorite, wherein the sodium chlorite reacts to form a bleaching agent, chlorine dioxide, wherein bleaching and acid hydrolysis of the cellulose pulp occurs in the single reaction vessel, (ii) mixing with a resonant acoustic mixer a high consistency pulp with an acidic solution in a reaction vessel, or a combination of (i) and (ii). In exemplary aspects, the method for reducing lignin content of a cellulose pulp, comprises mixing via resonant acoustic mixing a cellulose pulp in a basic solution at a temperature of greater than about 50° C. for at least one hour. In exemplary aspects, the method comprises mixing via resonant acoustic mixing a cellulose pulp in a basic solution comprising not more than about 8% (w/v) base at a temperature of about 60° C. to about 150° C., optionally, about 80° C. to about 140° C., for at least one hour, optionally, about 2 hours to about 20 hours.

In exemplary embodiments, the method of the present disclosure is as essentially described herein in the Examples section. Advantageously, the methods described herein may be scaled up to produce mass quantities of CNCs. In exemplary aspects, the methods of producing CNCs may be carried out in batch mode or in continuous mode to produce gram or kg quantities (e.g., 10 g, 100 g, 1 kg, 10 kg, 100 kg, 1000 kg) or more, e.g., ton quantities, of CNCs.

### Cellulose Sources and Pulp

With regard to the methods of the present disclosure, CNCs are made from a cellulose pulp, or pulp, made from a cellulose source. As used herein, the term “cellulose pulp” or “pulp” refers to a fibrous material prepared by separating cellulose fibers from the cellulose source. The cellulose fibers, in some instances, is separated from the cellulose source via chemical, thermal, or mechanical treatments, or a combination thereof. In exemplary aspects, the pulp is made via grinding a cellulose source using grindstones (e.g., silicon carbide or aluminum oxide grindstones) and/or ridged metal discs, called refiner plates. In exemplary aspects, the pulp is made via thermal treatment, and in some instances, steam is used to provide the thermal treatment. Use of steam to produce pulp reduces the total energy requirement to make pulp and also decreases the damage to cellulose fibers. In exemplary aspects, the pulp is made via chemical treatment of a cellulose source in a large vessel or digester. In exemplary instances, the chemical treatment comprises the kraft process, a sulfite process, and/or soda pulping. Additional treatments to produce pulp are known in the art. See, e.g., U.S. Pat. Nos. 7,306,698; 5,853,534; 4,260,452; 6,475,338; 5,593,544; 5,562,803; and 5,460,697. Advantageously, the methods of the present disclosure are not limited to any particular means of making the pulp.

Pulp varies in water content and the consistency of the pulp thus varies. In exemplary aspects, the methods are carried out with pulp comprising a minimal amount of water. In exemplary instances, the methods are carried out with a high consistency cellulose pulp or an ultra high consistency cellulose pulp. As used herein, the term “high consistency cellulose pulp” refers to a pulp having a water:solid pulp ratio of about 5:1 to about 8:1. As used herein, the term “ultra high consistency cellulose pulp” refers to a pulp having a water:solid pulp ratio greater than about 8:1. In exemplary aspects, the ultra high consistency cellulose pulp is a pulp having a water:solid pulp ratio between about 8:1 to about 15:1. In exemplary aspects, the pulp has a liquid to pulp ratio of about 5:1 to about 12:1, optionally, about 5:1 to about 8:1.

Pulp may vary by the source from which it was derived. The cellulose source may be a naturally occurring source or a synthetic source. In preferred embodiments, the cellulose source is a naturally occurring source, such as a plant, algae, fungi, bacteria, or tunicate which produces cellulose. Preferably, the cellulose source is a naturally occurring source, as the pulp derived from such sources is likely to be less expensive than pulp from a synthetic source. In exemplary aspects, the cellulose source is a plant. In some instances, the plant a woody plant, though, in preferred aspects, the plan is an non-woody plant, optionally, an herbaceous, non-woody plant. In exemplary aspects, the herbaceous, non-woody plant is a grass. For example, the grass may be a Miscanthus grass. In certain instances, the Miscanthus grass is a Miscanthus X Giganteus grass, which is described in the art. See, e.g., U.S. Patent Application Publication No. 2016/0319043 A1. Other grasses, such as wheat, straw, hemp, sugarcane, and switchgrass, may be used alone or in combination with a Miscanthus grass. Advantageously, the methods of the present disclosure are not limited to any particular cellulose source.

In exemplary aspects, the cellulose pulp has been pre-treated by a pre-treatment process. In exemplary instances, the pulp has been pre-treated by a process comprising (A) dispersing pulp in a 2% (w/v) sodium hydroxide solution and heating at a temperature of about 60° C. to about 140° C. for at least about 2 hours to about 20 hours with a mixer. In exemplary aspects, the process further comprises reducing the temperature to about 20° C. to about 30° C. and subsequently treating the pulp with hydrochloric acid. In some aspects, the process further comprises transferring the pulp treated with hydrochloric acid from the reaction vessel to a vacuum filtration vessel. In exemplary aspects, the process further comprises applying a vacuum to the contents in the vacuum filtration vessel to separate pulp from liquid and to form a pulp cake. Optionally, the process comprises washing the pulp cake within the vacuum filtration vessel with water at high speed in the presence of a filter to create a homogenous mixture of washed pulp.

### Acid Hydrolysis

In exemplary aspects, the methods of the present disclosure comprise an acid hydrolysis step. In exemplary instances, the methods of the present disclosure comprise mixing cellulose pulp with an acidic solution to form an acid-hydrolyzed cellulose pulp or acid-hydrolyzed CNCs. In exemplary aspects, the acidic solution comprises a mineral acid, optionally, hydrochloric acid or sulfuric acid. In some aspects, the acidic solution comprises about 2% (w/v) to about 10% (w/v) acid, optionally, about 4% (w/v) to about 6% (w/v). In certain instances, the cellulose pulp is mixed with the acidic solution at an acidic solution to cellulose pulp ratio of about 5:1 to about 15:1. For example, the cellulose pulp is mixed with the acidic solution at an acidic solution to cellulose pulp ratio of about 5:1 to about 14:1, about 5:1 to about 13:1, about 5:1 to about 12:1, about 5:1 to about 11:1, about 5:1 to about 10:1, about 5:1 to about 9:1, or about 5:1 to about 8:1. In exemplary instances, the cellulose pulp is mixed with the acidic solution at an acidic solution to cellulose pulp ratio of about 6:1 to about 15:1, about 7:1 to about 15:1, about 8:1 to about 15:1, about 9:1 to about 15:1, about 10:1 to about 15:1, about 11:1 to about 15:1, or about 12:1 to about 15:1. In exemplary aspects, the cellulose pulp is mixed with the acidic solution at an acidic solution to cellulose pulp ratio of about 5:1 to about 8:1, about 6:1 to about 8:1, about 7:1 to about 8:1, about 5:1 to about 7:1, or about 5:1 to about 6:1.

In exemplary aspects, the mixing of the cellulose pulp and the acidic solution occurs at a temperature of about 60° C. to about 140° C. (e.g., about 60° C. to about 130° C., about 60° C. to about 120° C., about 60° C. to about 110° C., about 60° C. to about 100° C., about 60° C. to about 90° C., about 60° C. to about 80° C., about 70° C. to about 140° C., about 80° C. to about 140° C., about 90° C. to about 140° C., about 100° C. to about 140° C., about 110° C. to about 140° C., about 120° C. to about 140° C., about 130° C. to about 140° C.). In exemplary aspects, the mixing of the cellulose pulp and the acidic solution occurs at a temperature of about 70° C. to about 80° C. (e.g., about 70° C., about 71° C., about 72° C., about 73° C., about 74° C., about 75° C., about 76° C., about 77° C., about 78° C., about 79° C., about 80° C.).

In exemplary aspects, the mixing of the cellulose pulp and the acidic solution occurs for at least one hour. In exemplary aspects, the mixing occurs for more than one hour, e.g., 2 hours, 3 hours, 4 hours, 5 hours, 6 hours, 7 hours, 8 hours, 9 hours, 10 hours or more. Advantageously, in certain embodiments, the presently disclosure methods are highly time-efficient and comprise mixing for not more than 30 hours (e.g., not more than 25 hours, not more than 20 hours).

In exemplary aspects, the cellulose pulp and acidic solution are further mixed with sodium chlorite and the mixing of such components occurs in a single reaction vessel. In exemplary aspects, the methods combine an acid hydrolysis step with a bleaching step. In exemplary aspects, the acid hydrolysis step and the generation of the bleaching agent is combined. In exemplary aspects, each of the acid hydrolysis step, the step of generating the bleaching agent, and the bleaching step is combined, and optionally each of these steps occurs in a single reaction vessel at the same time. In exemplary aspects, the cellulose pulp and acidic solution are mixed with sodium chlorite, which generates chlorine dioxide, a bleaching agent. In certain instances, the chlorine dioxide serves as the oxidizing agent which breaks down lignin structures of the cellulose pulp to produce a de-lignified cellulose pulp. In certain aspects in which acid hydrolysis and bleaching occurs, the cellulose pulp obtained is an acid-hydrolyzed, de-lignified cellulose pulp. In certain aspects, once acid hydrolysis occurs or once acid hydrolysis and bleaching occurs, CNCs are produced. Further aspects of the bleaching step are described below.

### Bleaching

In exemplary embodiments, the methods of the present disclosure comprise a bleaching step which leads to a de-lignified cellulose pulp or de-lignified CNCs. In some aspects, the bleaching occurs via oxidation with an oxidizing agent. In certain instances, the oxidizing agent is chlorine dioxide. In exemplary aspects, chlorine dioxide is generated by sodium chlorite, which reacts with hydrochloric acid to form chlorine dioxide in a reaction vessel. In exemplary aspects, sodium chlorite is added to the cellulose pulp in a repeated manner over a period of time. In exemplary aspects, sodium chlorite is added to minimize the amount of off-gassed chlorine dioxide. For example, sodium chlorite is added such that the amount of off-gassed chlorine dioxide is not more than about 10% (e.g., not more than about 9%, not more than about 8%, not more than about 7%, not more than about 6%, not more than about 5%, not more than about 4%, not more than about 3%, not more than about 2%, not more than about 1%) as determined by a chlorine dioxide detector, meaning that the continuous rate of chlorine dioxide degassing from the water never results in a concentration of chlorine dioxide at or above 10% in the headspace of a vented reaction vessel. In exemplary aspects, sodium chlorite is added to the cellulose pulp to produce about 50 μg to about 1000 82 g chlorine dioxide per L solution. In certain aspects, the amount of chlorine dioxide off-gassing is less than 2% of the gas phase in a reactor. In some instances, the chlorine dioxide generated is maintained at a ratio of chlorine dioxide to acidic solution of about 300 μg to about 500 μg. In some instances, the sodium chlorite is added in a repeated fashion, such that the addition of sodium chlorite occurs once every 30 minutes to about 3 hours. In exemplary aspects, sodium chlorite is added 2-5 times every 2-3 hours. In exemplary instances, the mixing of the sodium chlorite and cellulose pulp occurs in the presence of an acidic solution. In some aspects, the bleaching step and acid hydrolysis occur in the same reaction vessel. In some instances, the generation of bleaching agent, e.g., chlorine dioxide, occurs in the same reaction vessel such that the generation of bleaching agent and the bleaching step and acid hydrolysis step occurs in the same vessel. In exemplary aspects, the cellulose pulp is a high consistency cellulose pulp or an ultra high consistency cellulose pulp, and in some cases, the mixing occurs with a resonant acoustic mixer. Resonant acoustic mixing with a resonant acoustic mixer is further described below.

### Resonant Acoustic Mixing

In exemplary embodiments, the presently disclosed methods are advantageously carried out with minimal amounts of water leading to very high pulp consistencies and a reduced amount of waste water. In exemplary embodiments, the methods of the present disclosure comprise mixing with a resonant acoustic mixer a high consistency cellulose pulp or an ultra high consistency pulp with an acidic solution in a reaction vessel. In exemplary embodiments, the methods of the present disclosure comprise mixing with a resonant acoustic mixer a high consistency cellulose pulp or an ultra high consistency pulp with sodium chlorite in a reaction vessel. In exemplary embodiments, the methods of the present disclosure comprise mixing with a resonant acoustic mixer a high consistency cellulose pulp or an ultra high consistency pulp with an acidic solution and sodium chlorite in a reaction vessel. In exemplary aspects, the pulp has a liquid to pulp ratio of about 5:1 to about 12:1, optionally, about 5:1 to about 8:1. In some instances, the high consistency pulp has a water to pulp ratio of about 6:1 to about 8:1.

Resonant acoustic mixing (RAM), also known as resonant vibratory mixing, is a process by which energy is acoustically transferred to a mixture of components to be mixed. RAM is known in the art. See, e.g., U.S. Pat. No. 7,188,993 Michalchuk et al., Chem Commun (Camb) 54(32): 4033-4036 (2018); Valdez-Cruz et al., Microb Cell Fact 16(1): 129; doi: 10.1186/x12934-017-0746-1 (2017); and Tanaka et al., Anl Sci 33(1): 41-46 (2017). In exemplary aspects, a resonant acoustic mixer (or “RAM mixer”) comprises an oscillating mechanical driver that creates motion in a system of plates, weights and springs, and the energy is acoustically transferred to the material to be mixed. Without being bound to any particular theory, RAM provides a more efficient means of mixing. Resonant acoustic mixers, such as PCCA RAM™ (ResonantAcoustic® Mixer), LabRAM, PharmaRAM I, LabRAM II, OmniRAM, RAM 5, and RAM 55, are known in the art and are commercially available from, e.g., Resodyn™ Acoustic Mixers, Inc. (Butte, Mont.) or PCCA (Houston, Tex.).

In exemplary aspects, the methods comprises RAM and less than about 100 G of force acts on the cellulose pulp with the resonant acoustic mixer. In some aspects, less than about 95 G, less than about 90 G, or less than about 85 G of force acts on the cellulose pulp with the resonant acoustic mixer. Optionally, at least about 40 G, at least about 50 G or at least about 60 G of force acts on the cellulose pulp with the resonant acoustic mixer. In some instances, about 60 G to about 80 G of force acts on the cellulose pulp with the RAM mixer. In some aspects, about 60 G, about 61 G, about 62 G, about 63 G, about 64 G, about 65 G, about 66 G, about 67 G, about 68 G, about 69 G, about 70 G, about 71 G, about 72 G, about 73 G, about 74 G, about 75 G, about 76 G, about 77 G, about 78 G, about 79 G, or about 80 G of force acts on the cellulose pulp with the RAM mixer.

Advantageously, when a RAM mixer is used in the methods of the present disclosure, the mixing times may be reduced. For example, when the methods comprise mixing with a RAM mixer, the mixing times may be reduced by about 10%, about 20%, about 30%, about 40%, about 50%, or more, relative to the mixing times without a RAM mixer.

Furthermore, when a RAM mixer is used in the methods of the present disclosure, the heat duty (e.g., heat input) required for the reaction(s) (e.g., acid hydrolysis, oxidation) to take place in a reaction vessel or to maintain the temperature of the contents in the reaction vessel may be reduced. Without being bound to any particular theory, the high friction produced upon the mixing achieved with the RAM mixer yields heat such that the required heat input into the reaction vessel is reduced. In exemplary instances, when the methods comprise mixing with a RAM mixer, about 20% of the heat duty is generated from the mixing, such that the reaction may occur with less heat input or heat duty, relative to when a RAM mixer is not used. If the reaction is carried out in closed and insulated vessel, then pre heated pulp may be maintained in a desirable temperature range without the addition of additional radiant convective or conductive heat transfer. Also, for example, pulp slurries that are pre-heated and then placed in an insulated pressure vessel may not need any additional heating while under RAM mixing.

Additionally, when a RAM mixer is used, smaller amounts of reagents are needed, relative to when a RAM mixer is not used. In exemplary aspects, the concentration of chlorine dioxide is kept at a concentration between about 50 μg and about 100 μg per liter of solution, compared to the about 300 μg to about 500 μg when RAM is not used for mixing.

In exemplary aspects, when a RAM mixer is used, sodium chlorite dosing is repeated about 10 to about 15 (e.g., 10, 11, 12, 13, 14, or 15) times every 30-75 minutes (e.g., 30-70 minutes, 30-60 minutes, 30-55 minutes, 30-50 minutes, 30-45 minutes, 30-40 minutes, 30-35 minutes, 35-75 minutes, 40-75 minutes, 45-75 minutes, 50-75 minutes, 55-75 minutes, 60-75 minutes, 65-75 minutes, 70-75 minutes). This regimen of sodium chlorite differs from that when RAM is not used. When RAM is not used, sodium chlorite dosing may be repeated about 2 to about 5 (e.g., 2, 3, 4, 5) times every 2-3 hours (e.g., 2-2.5 hours, 2.5-3 hours).

### Method for Reducing Lignin Content

As described above, the present disclosure provides methods comprising an acid hydrolysis step, a de-lignifying or bleaching step, or both steps, with or without RAM.

The present disclosure also provides a method for processing a cellulose pulp to reduce the lignin content, which cellulose pulp then can undergo additional steps, e.g., acid hydrolysis, to produce CNCs. Accordingly, the present disclosure provides a method for reducing lignin content of a cellulose pulp. In certain aspects, the method comprises mixing via resonant acoustic mixing a cellulose pulp in a basic solution at a temperature of greater than about 50° C. for at least one hour. In exemplary aspects, the method comprises mixing via resonant acoustic mixing a cellulose pulp in a basic solution comprising not more than about 8% (w/v) base at a temperature of about 60° C. to about 150° C., optionally, about 80° C. to about 140° C., for at least one hour, optionally, about 2 hours to about 20 hours. In certain aspects, the basic solution comprises a hydroxide, optionally, comprising sodium hydroxide or calcium hydroxide. In exemplary instances, the basic solution comprises less than about 10% (w/v) base, e.g., about 1% (w/v) to about 5% (w/v) (e.g., about 1% (w/v), about 2% (w/v) about 3% (w/v), about 4% (w/v), about 5% (w/v)) sodium hydroxide or calcium hydroxide. In exemplary instances, the basic solution comprises about 2% (w/v) sodium hydroxide. In some aspects, the method comprises mixing via resonant acoustic mixing a cellulose pulp in a basic solution at a ratio of cellulose pulp to basic solution of about 10:1 to about 15:1, optionally, about 10:1 to about 14:1, about 10:1 to about 13:1, about 10:1, to about 12:1, about 10:1 to about 11:1, about 11:1 to about 15:1, about 12:1 to about 15:1, about 13:1 to about 15:1, about 14:1 to about 15:1, about 10:1, about 11:1, about 12:1, about 13:1, about 14:1, or about 15:1). In exemplary aspects, the method comprises mixing via resonant acoustic mixing a cellulose pulp in a basic solution at a temperature of about 60° C. to about 150° C., optionally, about 80° C. to about 140° C., for at least one hour, optionally, about 2 hours to about 20 hours.

In exemplary aspects, the method for reducing lignin content of a cellulose pulp, comprises mixing via resonant acoustic mixing a cellulose pulp in a basic solution at a temperature of greater than about 50° C. for at least one hour. In exemplary aspects, the method comprises mixing via resonant acoustic mixing a cellulose pulp in a basic solution comprising not more than about 8% (w/v) base at a temperature of about 60° C. to about 150° C. (e.g., about 60° C. to about 140° C., about 60° C. to about 130° C., about 60° C. to about 120° C., about 60° C. to about 110° C., about 60° C. to about 100° C., about 60° C. to about 90° C., about 60° C. to about 80° C., about 70° C. to about 150° C., about 80° C. to about 150° C., about 90° C. to about 150° C., about 100° C. to about 150° C., about 110° C. to about 150° C., about 120° C. to about 150° C., about 130° C. to about 150° C., about 140° C. to about 150° C.). In exemplary aspects, the mixing occurs at a temperature of about 70° C. to about 80° C. (e.g., about 70° C., about 71° C., about 72° C., about 73° C., about 74° C., about 75° C., about 76° C., about 77° C., about 78° C., about 79° C., about 80° C.). about 80° C. to about 140° C.

In exemplary aspects, the mixing occurs for at least one hour. In exemplary aspects, the mixing occurs for more than one hour, e.g., 2 hours, 3 hours, 4 hours, 5 hours, 6 hours, 7 hours, 8 hours, 9 hours, 10 hours or more. Advantageously, in certain embodiments, the presently disclosure methods are highly time-efficient and comprise mixing for not more than 30 hours (e.g., not more than 25 hours, not more than 20 hours).

In exemplary aspects, the lignin content of the cellulose pulp is reduced by more than about 10%, more than about 20%, more than about 30%, more than about 40%, more than about 50%, more than about 60%, more than about 70%, more than about 80%, or more than about 90%. In exemplary aspects, after carrying out the presently disclosed method for reducing lignin content, less than about 90%, less than about 80%, less than about 70%, less than about 60%, less than about 50%, less than about 40%, less than about 30%, less than about 20%, less than about 10%, or less than about 5% of the lignin content of the cellulose pulp is present.

In exemplary embodiments, the presently disclosed method for reducing lignin content is part of a method of producing CNCs. Accordingly, the present disclosure provides a method of producing CNCs from a cellulose pulp having a reduced lignin content, which cellulose pulp is produced by carrying out the presently disclosed methods for reducing lignin content of a cellulose pulp. In exemplary aspects, the method of producing CNCs comprises reducing lignin content of a cellulose pulp in accordance with methods of the present disclosure and one or more of an acid hydrolysis step, a bleaching agent generation step, and a bleaching step.

### Reaction Vessel

As used herein, the term reaction vessel refers to any open or closed container suitable for holding components of a mixture. In exemplary aspects, the reaction vessel is made of a metal, glass, plastic, ceramic, or a combination thereof. In exemplary instances, the reaction vessel has a volumetric capacity of more than 250 mL, more than 500 mL, more than 750 mL, more than one L, more than 10 L, more than 100 L, more than 1000 L, more than 10,000 L. In certain aspects, the reaction vessel comprises one or more inlets and/or one or more outlets. In certain aspects, the reaction vessel comprises a filter or a screen. In exemplary aspects, the reaction vessel is suitable for receive acoustic energy from a RAM mixer.

### Additional Steps

The methods of the present disclosure may comprise the above described step(s) alone or in combination with other steps. The methods may comprise repeating any one of the above-described step(s) and/or may comprise additional steps, aside from those described above. For example, the presently disclosed methods may comprise additional washing steps. The methods of the present disclosure may further comprise, for instance, altering the pH after the bleaching step. In exemplary aspects, the method comprises mixing the bleached cellulose pulp with sodium hydroxide to make the pH more basic. The methods of the present disclosure may further comprise, for instance, altering the temperature. For example, the method may comprises cooling the temperature after bleaching the cellulose pulp. The method in some aspects, further comprises one or more filtration steps, wherein CNCs are filtered and the filtrate is optionally mixed with sodium thiosulfate to neutralize the pH and to remove the chlorite ions (by-products of the oxidation reaction made during the bleaching step). The methods may additionally comprise one or more de-watering or drying steps during which CNCs are de-watered or dried.

### CNCs, Compositions, and Articles of Manufacture

The present disclosure provides the CNCs produced by any of the presently disclosed methods of making CNCs. In exemplary instances, the dimensions of the CNCs are determined to have a distribution of about 200 nm to about 500 nm, e.g., about 200 nm to about 400 nm, about 200 nm to about 250 nm, about 220 to about 330 nanometers) with an average length of about 200 to about 500 nm (e.g., about 200 nm to about 400 nm, about 200 nm to about 300 nm, about 250 nm to about 300 nm, about 270 nanometers). In some aspects, the average width of the CNCs is about 1 to about 20 nm (e.g., about 1 to about 15 nm, about 1 nm to about 10 nm, about 1 nm, about 2 nm, about 3 nm, about 4 nm, about 5 nanometers, about 6 nm, about 7 nm, about 8 nm, about 9 nm, about 10 nm). In exemplary instances, the CNCs crystallinity index, as performed by the peak deconvolution method, is greater than about 85% or greater than about 90%. In some aspects, the crystallinity value of the CNCs is about 90%, about 91%, about 93%, about 94%, about 95%, about 96%, about 97%, about 98%, about 99%).

The present disclosure additionally provides compositions and articles of manufacture each comprising CNCs produced by the presently disclosed methods. In exemplary aspects, the composition comprises CNCs in an aqueous solution. In exemplary aspects, the percentage of CNCs in the aqueous solution is about 5% to about 50% (w/v). In exemplary aspects, the composition comprises CNCs in an aqueous solution and is stored frozen. In exemplary aspects, the composition comprises CNCs as a dry powder. In exemplary aspects, the composition comprises a gel (e.g., an aerogel or hydrogel) comprising the CNCs. In exemplary aspects, the CNCs of the composition are cast as a film.

In exemplary instances, the article of manufacture is a vial, bag, syringe, or other suitable container holding the CNCs of the present disclosure. In some aspects, the article is a membrane, film, a drug delivery agent, a coating, support for a catalyst, an energy storage material, a reinforced plastic, an aerogel, a hydrogel, a pickering emulsifier, a textile, a filtration system, a molecular scaffold, composite material, or an electrospun fiber. In exemplary instances, the article is a membrane, film, coating, or composite material comprising the CNCs of the present disclosure.

The following examples are given merely to illustrate the present invention and not in any way to limit its scope.

### EXAMPLES

### Example 1

This example describes an exemplary method of pre-treating pulp.

Cellulose pulp was thoroughly dispersed in a 2% (w/v) solution of sodium hydroxide at 10:1 to 15:1 ratio of NaOH solution to pulp. The resulting mixture was heated in a reaction vessel to 98° C. with mixing. The pulp was mixed at slow speeds to minimize shear-induced aggregation of pulp. The reaction proceeded for 10 to 15 hours. The temperature was reduced to room temperature and the mixture was neutralized with hydrochloric acid before removal from the reactor and placement into a vacuum filtration vessel. The liquid was separated and a cake was allowed to form on the surface of the filter through vacuum filtration. Washing was conducted by filling the filtration vessel with clean water. The pulp was then mixed at high speed to create a homogeneous mixture during filtration. This prevented the retention of hydrolysis products and allowed the washing to be completed with less water.

### Example 2

This example describes an exemplary method of producing CNCs wherein acid hydrolysis and bleaching steps are performed in the same reaction vessel.

Cellulose pulp was pre-treated as described in Example 1 and then placed in a cylindrical jacketed reactor containing a 4-6% (w/v) solution of hydrochloric acid at a ratio of acidic solution to pulp of about 10:1 to about 15:1 and heated to 70-80° C. under mixing. After 2-4 hours, 6.5 mg of sodium chlorite per gram of cellulose pulp is added. Sodium chlorite reacts with hydrochloric acid to generate chlorine dioxide which serves as an oxidizing agent that allows for the removal of lignin. The sodium chlorite dosing was repeated 2-5 times every 2-3 hours. After the last dose of sodium chlorite the reaction is allowed to continue for another 2 hours.

The stepwise dosing of sodium chlorite was performed for several reasons. First, it minimized the production of excess chlorine dioxide. This limited the off-gassing of chlorine dioxide which prevents waste of reagents and limits pollution. Second, hydrochloric acid, which was the catalyst for the hydrolysis reaction, is consumed in the generation of chlorine dioxide. A slow and spread out generation of chlorine dioxide meant that the concentration of hydrochloric acid can be maintained within optimal levels for longer periods of time without using higher concentrations of hydrochloric acid.

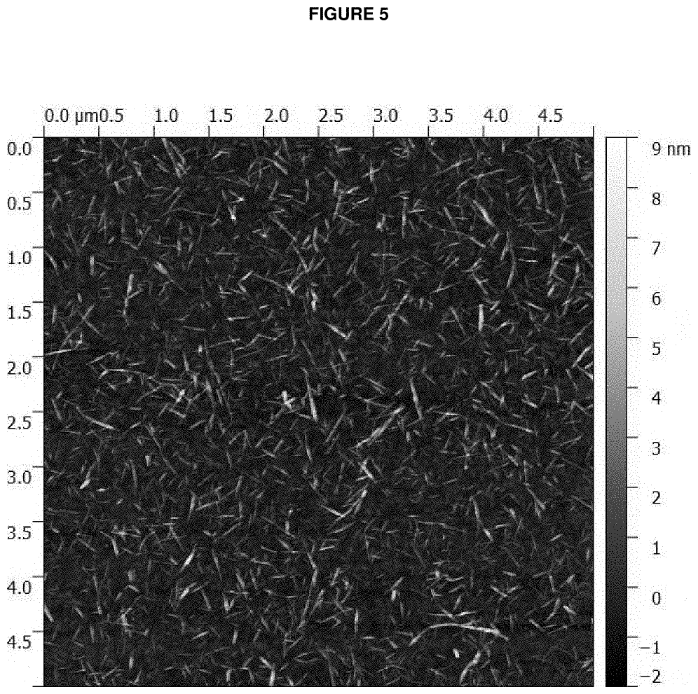

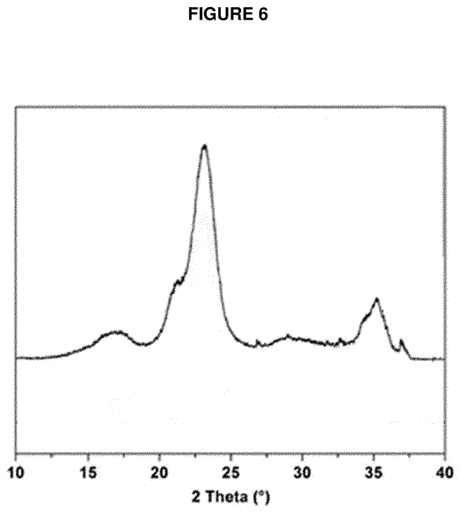

Cellulose nanocrystals were recovered and washed with centrifugation. The CNC was then purified by dialysis against deionized water and then freeze dried. After weighing the yield was determined to be 42%. The CNCs were characterized by atomic force microscopy (FIG. 5) and x-ray diffraction (FIG. 6) which determined that the crystals had an average length of 298 nanometers and a crystallinity index of 92%.

### Example 3

This example describes an exemplary method of producing CNCs using a resonant acoustic mixer.

Cellulose pulp was pre-treated as described in Example 1 and placed in a reaction vessel containing 4-6% (w/v) hydrochloric acid solution. The amount of HCl solution and pulp is mixed at a ratio different from that of Example 2. The HCl solution to pulp ratio here was about 6:1 to about 8:1 and heated to 70-80° C. under acoustic mixing at 60 to 80 G using a Resodyne LabRAM II resonant acoustic mixer.

Less sodium chlorite was added in this method due to the resonant acoustic mixing. Sodium chlorite was added on a basis of 1 mg sodium chlorite per gram of pulp. As in Example 2, sodium chlorite reacted with HCl to generate chlorine dioxide which depolymerizes the lignin which allows its separation from the cellulose fibrils. The sodium chlorite dosing was repeated 10-15 times every 30 minutes to an hour and a half. After the last dose of sodium chlorite, the reaction was allowed to continue for another 2 hours.

This method allows the pulp to be processed at liquid levels of about 6:1 to about 8:1 when mixed at 60 G to 100 G. The use of resonant acoustic mixing allowed for shorter residence times. Additionally heat duty was reduced as the mixing of the pulp generates approximately 20% of the heat required.

### Example 4

This example describes an exemplary post-bleaching process.

After the removal of lignin is complete, the pH was made basic through the addition of sodium hydroxide under mixing and cooling, which helps solubilize the oxidized lignin. The contents of the reactor were cooled and then drained into a filtration apparatus. The cellulose nanocrystals were then dewatered. The filtrate is reused for following on batches while a portion is purged into a container containing an acidic solution of sodium thiosulfate. As the filtrate enters the container the solution was neutralized. Chlorite ions and any residual chlorine dioxide were reduced by sodium thiosulfate producing chloride and sulfate ions. The CNC was then washed using the same procedure described in Example 1.

### Example 5

This example describes the characterization of the CNCs produced by Examples 2 and 3.

CNC was characterized using atomic force microscopy (AFM) and x-ray diffraction (XRD). An AFM image is shown in FIG. 5 and an XRD pattern is shown in FIG. 6. The dimensions of the crystals were determined to have a distribution of 220-330 nanometers with an average length of 270 nanometers. The average width was 5 nanometers. Determination of the CNCs crystallinity index was performed by the peak deconvolution method and resulted in a crystallinity value of 93%.

### Example 6

This example describes resonant acoustic mixing of a cellulose pulp with an acidic solution achieved by the resonant acoustic mixer wherein force was varied. Reaction vessels containing acidic slurries of cellulose pulp with liquid to pulp ratios of 5:1, 6:1, 7:1, 8:1, 9:1, and 10:1 were subjected to resonant acoustic mixing at forces between 20-100 G. The effectiveness of mixing was determined to be inversely proportional to the concentration of the slurry with higher concentrations requiring more force to obtain adequately mixed pulp. If the force was too low for a specific concentration of pulp the mixing would not occur and the pulp would vibrate. Levels of mixing that were too high caused the entire mass of the pulp to travel from the top to the bottom of the vessel as a single plug without mixing. At the appropriate level of force the slurry of pulp disperses in amorphous spheres of pulp with diameters generally 1 centimeter or less. Over time the spheres become smaller as the fibers are mechanically and chemically separated.

### Example 7

This example describes a method of continuous flow through a reaction vessel under resonant acoustic mixing. Pulp at a concentration of 5:1 can be heated and pumped into the base of the reaction vessel being subjected to RAM. A mesh screen placed near the top of the vessel that provides space for the mixing to occur below. Pulp mixed below will strike the mesh screen and bounce back towards the bottom until the pulp is small enough to pass through the mesh. This size excluded pulp, or CNC aggregate is then ejected through a port at the top of the vessel by the force of the acoustic mixing. This material may then be collected and pumped to a second stage reactor or washed and purified as the final product.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range and each endpoint, unless otherwise indicated herein, and each separate value and endpoint is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for producing acid-hydrolyzed, de-lignified cellulose nanocrystals (CNCs), said method comprising mixing in a single reaction vessel a cellulose pulp, an acidic solution; and sodium chlorite, wherein the sodium chlorite reacts to form a bleaching agent, chlorine dioxide, wherein bleaching and acid hydrolysis of the cellulose pulp occurs in the single reaction vessel.

2. The method of claim 1, wherein the mixing is carried out with a resonant acoustic mixer.

3. A method for producing acid-hydrolyzed cellulose nanocrystals (CNCs), said method comprising mixing with a resonant acoustic mixer a high consistency cellulose pulp with an acidic solution in a reaction vessel.

4. The method of claim 3, wherein the high consistency cellulose pulp and acidic solution are additionally mixed with sodium chlorite to obtain acid-hydrolyzed and de-lignified CNCs.

5. The method of claim 4, wherein the high consistency cellulose pulp, acidic solution, and sodium chlorite are mixed in a single reaction vessel, wherein the sodium chlorite reacts to form a bleaching agent, chlorine dioxide, wherein bleaching and acid hydrolysis of the cellulose pulp occurs in the single reaction vessel.

6. The method of claim 1, wherein (i) the acidic solution comprises a mineral acid, optionally, hydrochloric acid or sulfuric acid and/or (ii) the acidic solution comprises about 2% (w/v) to about 10% (w/v) acid, optionally, about 4% (w/v) to about 6% (w/v) acid.

7. The method of claim 1, wherein the acidic solution comprises about 2% (w/v) to about 10% (w/v) acid, optionally, about 4% (w/v) to about 6% (w/v) acid.

8. The method of claim 1, comprising mixing the cellulose pulp at an acidic solution to pulp ratio of about 5:1 to about 15:1, optionally, about 5:1 to about 8:1 or about 6:1 to about 8:1.

9. The method of claim 1, wherein the mixing occurs at a temperature of about 60° C. to about 150° C., optionally, for at least one hour.

10. The method of claim 1, wherein the sodium chlorite generates chlorine dioxide in the reaction vessel, and the amount of off-gassed chlorine dioxide is not more than about 10%, as determined by a chlorine dioxide detector, or about 50 μg to about 500 μg chlorine dioxide per L pulp and acidic solution is produced.

11. The method of claim 2, wherein less than about 100 G of force acts on the cellulose pulp with the resonant acoustic mixer, optionally, wherein at least about 60 G of force acts on the cellulose pulp with the resonant acoustic mixer.

12. The method of claim 11, wherein about 60 G to about 80 G of force acts on the cellulose pulp with the resonant acoustic mixer.

13. The method of claim 1, wherein the reaction vessel comprises a filter or a screen.

14. The method of claim 1, wherein the high consistency pulp has a liquid to pulp ratio of about 5:1 to about 12:1, optionally, about 5:1 to about 8:1.

15. A method for reducing lignin content of a cellulose pulp, said method comprising mixing via resonant acoustic mixing a cellulose pulp in a basic solution comprising not more than about 8% (w/v) base at a temperature of about 60° C. to about 150° C., optionally, about 80° C, to about 140° C., for at least one hour, optionally, about 2 hours to about 20 hours.

16. The method of claim 15, wherein the basic solution comprises a hydroxide, optionally, comprising sodium hydroxide or calcium hydroxide.

17. The method of claim 15, wherein the basic solution comprises about 2% (w/v) sodium hydroxide.

18. The method of claim 15, comprising mixing via resonant acoustic mixing a cellulose pulp in a basic solution at a ratio of cellulose pulp to basic solution of about 10:1 to about 15:1.

19. The method of claim 15 further comprising (i) mixing in a single reaction vessel a cellulose pulp, an acidic solution and sodium chlorite, wherein the cellulose pulp, acidic solution, and sodium chlorite are mixed in the single reaction vessel at the same time, (ii) mixing with a resonant acoustic mixer a high consistency pulp with an acidic solution in a reaction vessel, or a combination of (i) and (ii).

20. (canceled)
